(19) United States
(12) Patent Application Publication
(10) Pub. No.: US 2014/0029968 A1
(43) Pub. Date: Jan. 30, 2014

(54) IMAGE HEATING APPARATUS

(71) Applicant: CANON KABUSHIKI KAISHA, Tokyo (JP)

(72) Inventor: Masayuki Tamaki, Abiko-shi (JP)

(21) Appl. No.: 13/946,521

(22) Filed: Jul. 19, 2013

(30) Foreign Application Priority Data
Jul. 24, 2012 (JP) 2012-163626

(51) Int. Cl. G03G 15/20

(52) U.S. Cl. CPC G03G 15/2064
USPC 399/67

(57) ABSTRACT

An image heating apparatus is provided with a mechanism for changing pressure at a nip portion to prevent wrinkle in a rear end portion of an envelope in fixing the envelope is provided. If the width size of the envelope is equal to a predetermined width or less, the pressure at the nip portion is reduced.

### BACKGROUND OF THE INVENTION

1. Field of the Invention

The present disclosure relates to image heating apparatuses for heating a toner image on a recording material.

The image heating apparatuses can be applied, for example, to image forming apparatuses for forming an image on a recording material using an appropriate image forming principle or method such as an electrophotographic image forming process, an electrostatic recording image forming process, and a magnetic recording image forming process. Specifically, the image heating apparatuses can be applied to image forming apparatuses such as copying machines, printers (for example, laser beam printers and light-emitting diode (LED) printers), facsimile apparatuses, multifunction peripherals having these functions, and word processors.

2. Description of the Related Art

For the sake of simplicity, a fixing device that is an example of the image heating apparatus will be described. A fixing device for heating and pressing an unfixed toner image formed on a recording material to fix the image on the recording material is provided in conventional image forming apparatuses such as electrophotographic copying machines.

The fixing device has a pair of rotatable members, and at a nip portion therebetween, fixes the toner image while nipping and conveying the recording material bearing the unfixed toner image.

In the market, there is a growing need for image formation on increasingly varied types of recording materials than before. One of that need is image formation on envelopes. The term envelope means an item for enclosing letters, pictures, and the like, and the delivery methods of the envelopes are not limited to mail delivery or delivery by hand.

For example, Japanese Patent Application Laid-Open No. 2004-279702 discusses an apparatus having a mechanism for preventing formation of wrinkles in a rear end portion of an envelope in the conveyance direction. Specifically, the apparatus is provided with a switching mechanism for switching pressures per unit area of a first pressure roller and a second pressure roller against a fixing roller between a normal mode and an envelope mode. In the envelope mode, as compared to the normal mode for fixing a plain paper, the pressure applied to the fixing roller per unit area of both the first pressure roller and the second pressure roller are reduced. Thus, the generation of wrinkles in envelopes can be prevented.

However, in the apparatus described in Japanese Patent Application Laid-Open No. 2004-279702, the pressures are uniformly reduced irrespective of width of envelopes. Consequently, if the fixing processing (image heating processing) is performed on a wide envelope, wrinkles may be formed. This is because the reduction of the pressures on the wide envelope in the fixing processing causes reduction of pressure in the nip portion at its end portions in the longitudinal direction, and results in reduction of envelope conveyance power at the end portions in the longitudinal direction as compared to the conveyance power at the center portion in the longitudinal direction. That is, both end portions of the envelope are pulled toward the center side, and thereby wrinkles are formed in the envelope.

### SUMMARY OF THE INVENTION

The present disclosure relates to image heating apparatuses capable of satisfactorily performing image heating processing on envelopes of narrow widths as well as envelopes of wide widths.

According to an aspect disclosed herein, an image heating apparatus is provided. The image heating apparatus includes first and second rotatable members configured to heat a toner image on a recording material at a nip portion therebetween, a pressing mechanism configured to press the first rotatable member and the second rotatable member to come in contact with each other, and a controller configured to control a pressure applied by the pressing mechanism. In a case where image heating processing is performed on an envelope as the recording material, if the envelope has a width wider than a predetermined width, the controller sets the pressure to a first pressure, and if the envelope has a width equal to the predetermined width or less, the controller sets the pressure to a second pressure lower than the first pressure.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration model of an image forming apparatus.

FIG. 2 is a perspective view of a fixing device.

FIGS. 3A and 3B are a front view and a cross-sectional front view of the fixing device.

FIGS. 4A and 4B are a left side view and a partially cutaway left side view of the fixing device.

FIGS. 5A and 5B are a right side view and a partially cutaway right side view of the fixing device.

FIG. 6 is an enlarged right side view taken along the (6)-(6) line in FIG. 3A.

FIG. 7 illustrates a state where divided movable cores in a coil unit of FIG. 6 have been moved upward to a second distant position.

FIG. 8 illustrates a crown amount of a pressure application member in the fixing device.

FIG. 9 is s view illustrating a layer structure of a fixing belt.

FIG. 10 is a model figure illustrating an exaggerated reverse crown shape of a pressure roller.

FIG. 11 is a perspective view illustrating an exciting coil and a divided core group in a coil unit (induction heating device).

FIG. 12 is an external perspective view illustrating a pair of left and right magnetic flux shielding plates and a shift mechanism which is partially cut out.

FIG. 13 illustrates variable pressure cams (eccentric cams).

FIGS. 14A to 14D illustrate a pressure changing method.

FIG. 15 illustrates pressure distribution at a nip portion in the longitudinal direction in each pressure control mode of the fixing device.

FIG. 16 illustrates an envelope wrinkle generating mechanism.

FIG. 17 is a control block diagram illustrating a pressure change control system.

FIG. 18 illustrates a control flowchart.

FIG. 19 illustrates a control timing chart.

FIG. 20 illustrates a control flowchart.

### DESCRIPTION OF THE EMBODIMENTS

Various exemplary embodiments, features, and aspects of the disclosure will be described in detail below with reference to the drawings.

Hereinafter, exemplary embodiments applied to an electrophotographic color copying machine including a plurality of drums will be described. However, in addition to the electrophotographic color copying machine, the exemplary embodiments can be applied to various types of electrophotographic copying machines, or printers, monochromatic image forming apparatuses, and image forming apparatuses other than the electrophotographic type.

In the descriptions, the terms “envelope” and “mailing envelope” mean articles formed by layering a plurality of sheets, having folds, and having baggy shapes (hereinafter simply referred to as envelope). The envelope is an article for enclosing letters, pictures, and the like, and the delivery methods are not limited to mail delivery, courier service, or delivery by hand. Recording materials different from the envelope mean paper of one sheet, for example, plain paper, thick paper, postcards, labels, and transparencies. Including the envelope, these materials are referred to as recording material.

### (1) Image Processing Apparatus

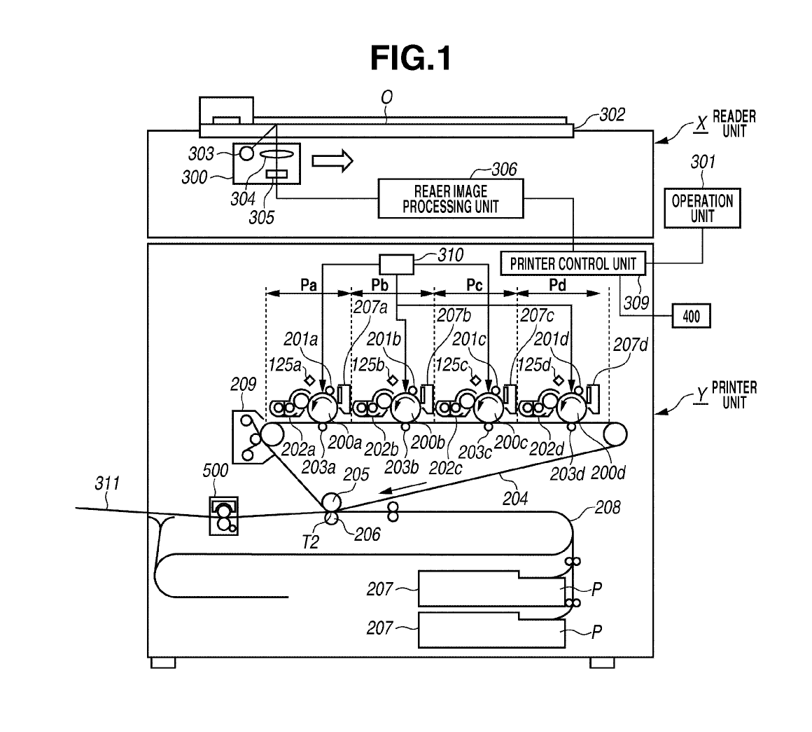

FIG. 1 is a schematic structure of an image forming apparatus. The image forming apparatus is an electrophotographic color copying machine provided with a fixing device 500 serving as an image heating apparatus according to the exemplary embodiment of the present disclosure.

An operation of full-color image formation is described. A movable reading optical system unit 300 photoelectrically reads an image surface of a color document O with the face downward on a document positioning glass 302 of a reader unit X, and performs color separation processing. The unit 300 reciprocates along the lower surface of the glass 302, as shown in the drawing, from the home position at the left side to the right side as indicated by the arrow. After performing a forward travel for a predetermined distance, the unit 300 performs a backward travel to return to the initial home position.

During the forward travel of the unit 300, the image surface of the document O set downward is irradiated by a light source 303 to form an image on a charge coupled device (CCD) sensor 305 via an optical system 304, and the photoelectric reading processing is performed while performing color separation. Thus, the document image is converted into an electrical signal data string for each line.

The image signal acquired by the sensor 305 is sent to a printer control unit (control circuit unit) 309 in a printer unit Y via a reader image processing unit 306, and image processing corresponding to the print is performed on the image signal. The control unit 309 can receive, as an image signal, an external input from an external host device 400 such as a print server (PC). The image signal is converted into a laser beam which is subjected to pulse width modulation (PWM) by the control unit 309. A polygon scanner 310 irradiates and scan four electrophotographic photosensitive drums (image bearing members) 200a to 200d of image forming portions Pa to Pd with the beam. The drums 200a to 200d are driven to rotate in the counterclockwise direction indicated by the arrow at a predetermined speed.

The image forming units Pa, Pb, Pc, and Pd are electrophotographic image forming units for forming toner images (unfixed images) of yellow (Y), magenta (M), cyan (C), and black (Bk) on the drums 200a, 200b, 200c, and 200d, respectively. The image forming mechanism and image forming process of the image forming units Pa to Pd are similar, and consequently, the image forming unit Pa of yellow will be described below in detail, and descriptions of the other image forming units Pb, Pc, and Pd will be omitted.

In the image forming portion Pa of yellow, the surface of the drum 200a being driven and rotated is charged at a predetermined potential by a primary charger 201, and exposed by the scanner 310 to the beam to form an electrostatic latent image. The latent image is developed by a developer 202a as a toner image (developer image) of yellow. The toner image is primary-transferred on an intermediate transfer belt 204 by a primary transfer roller 203a.

The belt 204 that serves as an intermediate transfer member moves in a cyclic movement at the same speed as the speed of the drum 200a in the clockwise direction indicated by the arrow. To the roller 203a, a primary transfer bias of the opposite polarity of the toner is applied from the back surface of the belt 204 for discharge. As a result, the image is sequentially transferred from the drum 200a side to the belt 204 side. After the image transfer to the belt 204, the surface of the drum 200a is cleaned with a cleaner 207a.

The toner image on the belt 204 is sequentially conveyed to the subsequent image forming units Pb, Pc, and Pd as the belt 202 continues to move, and thus toner images of M, C, and Bk are overlapped with each other and transferred in this order. The images pass through the image forming unit Pd, and thereby a combined image of the overlapped images of four colors of Y, M, C, and Bk is formed on the belt 204. The image on the belt 204 is secondarily transferred from the belt 204 side to the recording material P side in a collective manner at a secondary transfer unit (nip portion) T2. The nip portion T2 includes a secondary transfer inner roller 205 and an outer roller 206. After the image transfer to the recording material P, the surface of the belt 204 is cleaned with a cleaner 209.

The recording material P is separated and conveyed one by one from a paper feed cassette 207 on a sheet path 208, fed into the nip portion of the belt 204 and the outer roller 206 at the secondary transfer portion T2 at a predetermined control timing, and nipped and conveyed. The toner image on the belt 204 is electrostatically transferred on the recording material P by a secondary transfer electric field of the opposite polarity to the toner charge polarity applied between the rollers 205 and 206.

The recording material P that has passed through the secondary transfer portion T2 is separated from the surface of the belt 204, and fed into the fixing device 500. The unfixed toner image on the recording material is heated and pressed with the fixing device 500, and fixed to be a fixed image. The recording material P passes through the fixing device 500, and discharged to a discharge portion 311 as a formed image.

### (2) Fixing Device

With respect to the fixing device 500 serving as an image heating apparatus and members constituting the fixing device, a longitudinal direction (width direction) refers to an axis direction (thrust direction) of the rotatable member, or a direction perpendicular to the recording material conveyance direction at the nip portion which conveys the recording material, or a direction parallel to this direction. Further, a widthwise direction refers to a direction parallel to the recording material conveyance direction at the nip portion. As will be described below, the longitudinal direction of the fixing device (the fixing belt and the nip portion) is substantially parallel to the width direction of envelopes. In other words, the width of envelope is a length in the width direction.

With respect to the fixing device, a front surface refers to a surface of the fixing device viewed from the recording material feeding side, and a rear surface refers to the opposite surface (recording material discharge side) of the front surface. Left and right refer to the left side and the right side viewed from the front side of the device. Up and down refer to the upper side and the lower side in the direction of gravity. An upstream side and a downstream side refer to the upstream side and the down stream side with respect to the recording material conveyance direction. A recording material size (paper size) or a paper-passing width of a recording material refers to a recording material size (width size) in the direction perpendicular to the recording material conveyance direction on the recording material surface.

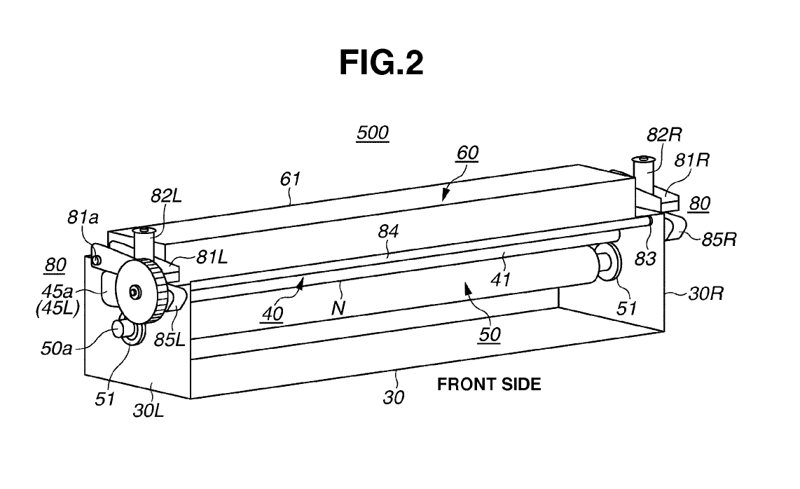

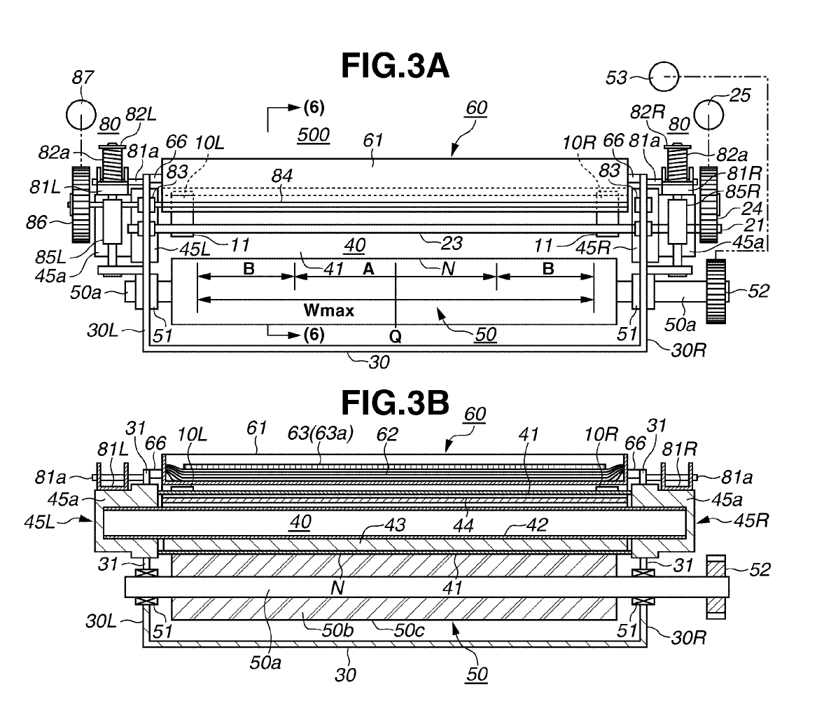

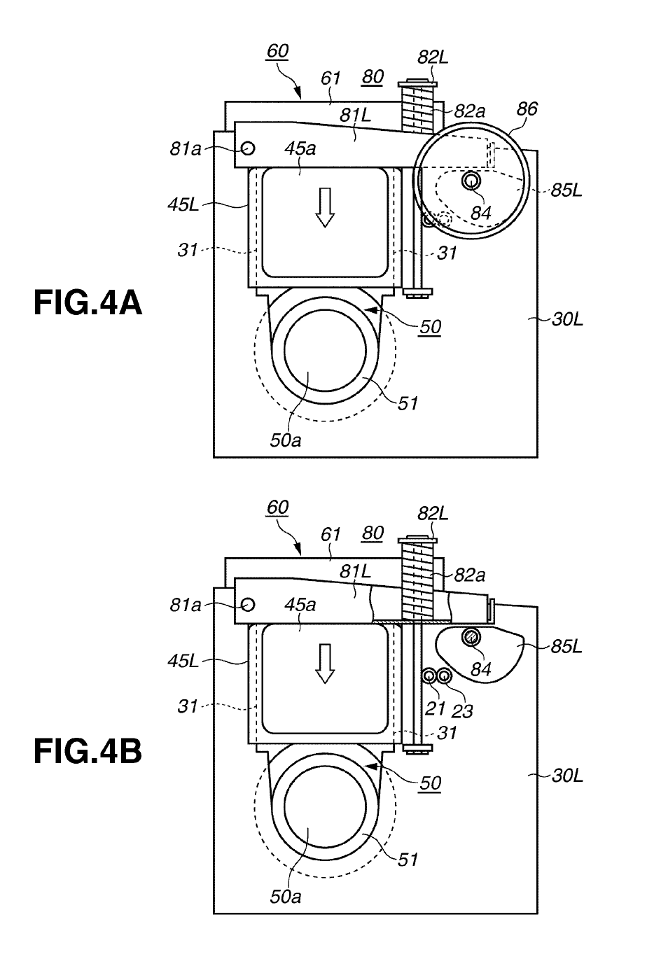

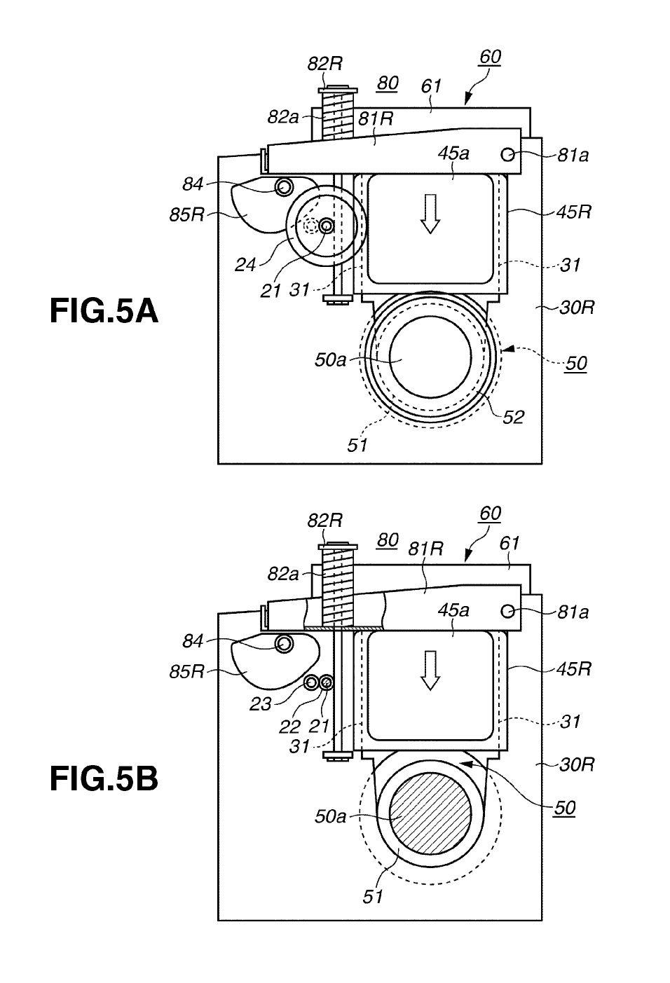

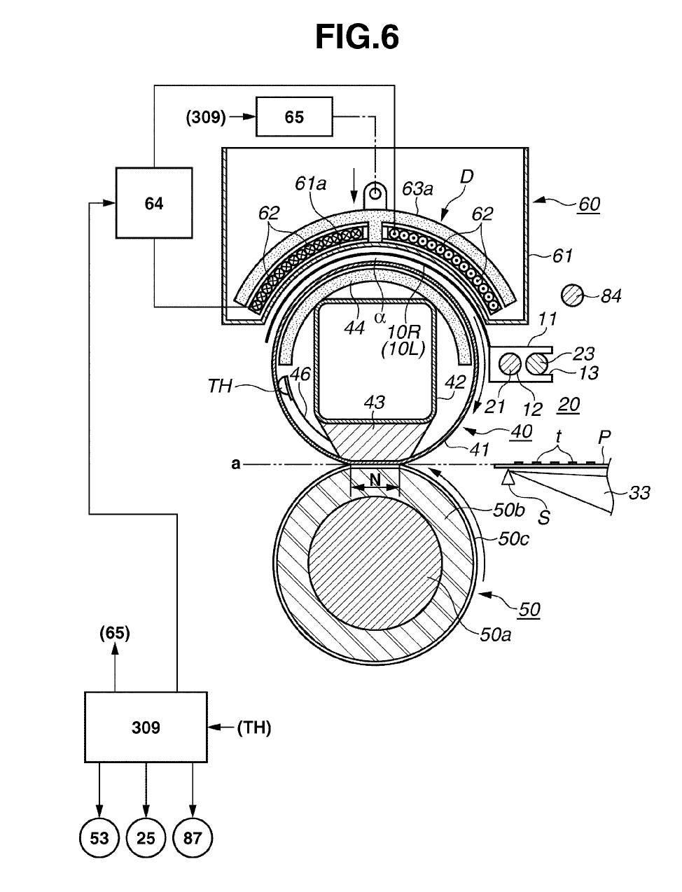

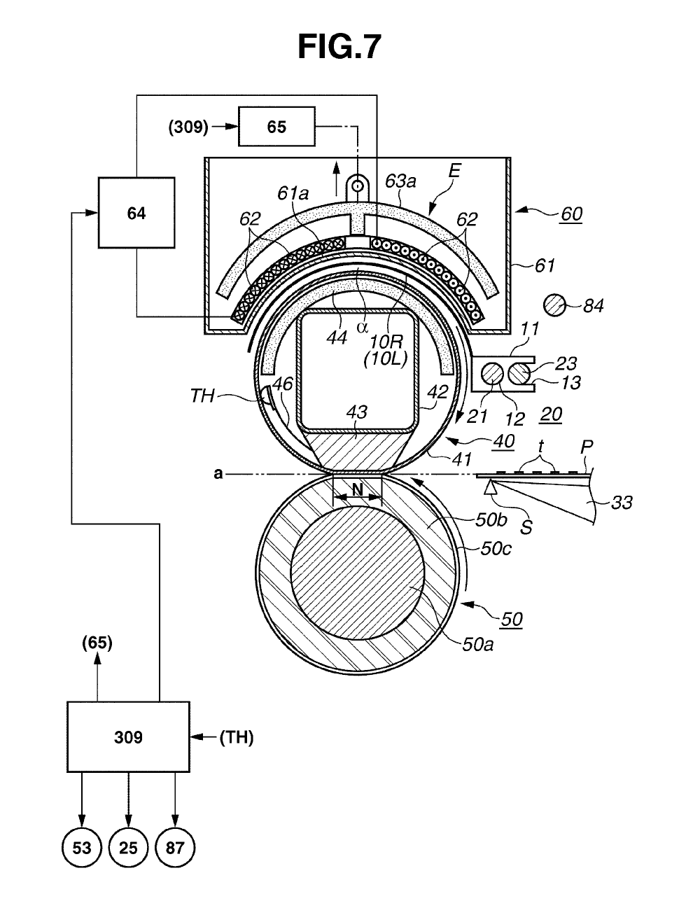

FIG. 2 is a perspective view illustrating the fixing device 500. FIGS. 3A and 3B are a front view and a cross-sectional front view of the fixing device 500. FIGS. 4A and 4B are a left side view and a partially cutaway left side view of the fixing device 500. FIGS. 5A and 5B are a right side view and a partially cutaway right side view of the fixing device 500. FIG. 6 is an enlarged right side view taken along the (6)-(6) line in FIG. 3A. FIG. 7 illustrates a state where divided movable cores in a coil unit in FIG. 6 have been moved to a second distance position above.

The fixing device 500 according to the exemplary embodiment is an image heating apparatus of an external heating type electromagnetic induction heating type. The fixing device 500 includes, roughly, the following members and mechanisms.

a: A heating assembly 40 including an endless belt (hereinafter, referred to as fixing belt or belt) 41 having flexibility. The endless belt serves as a rotatable member contacting the image bearing surface of the recording material P.

b: A pressure roller 50 having elasticity. The roller serves as a rotatable member facing the fixing belt 41 of the heating assembly 40.
c: A pressure mechanism 80 for pressing the fixing belt 41 and the pressure roller 50 to come in contact with each other to form a nip portion N.
d: A pressure changing mechanism for changing the pressure at the nip portion N with pressure mechanisms 80L and 80R.
e: A unit (induction heating device) 60 having an exciting coil serving as a heater for heating the fixing belt 41.
f: Magnetic flux shielding plates (magnetic flux shielding members) 10L and 10R and shift mechanism 20 for the plates. The above-mentioned members and mechanisms are provided between left and right side plates 30L and 30R of a device chassis 30.

### (2-1) Heating Assembly 40

The heating assembly 40 includes the cylindrical fixing belt 41 having flexibility that serves as a rotatable image heating member. The fixing belt 41 includes magnetic members (a metal layer and a conductive member) that generate heat in electromagnetic induction when they pass through a magnetic field generated by the coil unit 60 described below exists. The heating assembly 40 further includes a metallic stay 42 inside the belt 41. To the lower surface of the stay 42, a pressing pad (nip pad) 43 serving as a pressure application member is attached along the longitudinal direction.

The pad 43 is a member for applying a predetermined pressure between the fixing belt 41 and the pressure roller 50 to form the fixing portion (fixing nip portion) N. The pad 43 is formed of a heat-resistant resin. The stay 42 needs to have stiffness enough to apply a pressure on the nip portion N, and in the exemplary embodiment, an iron stay is employed.

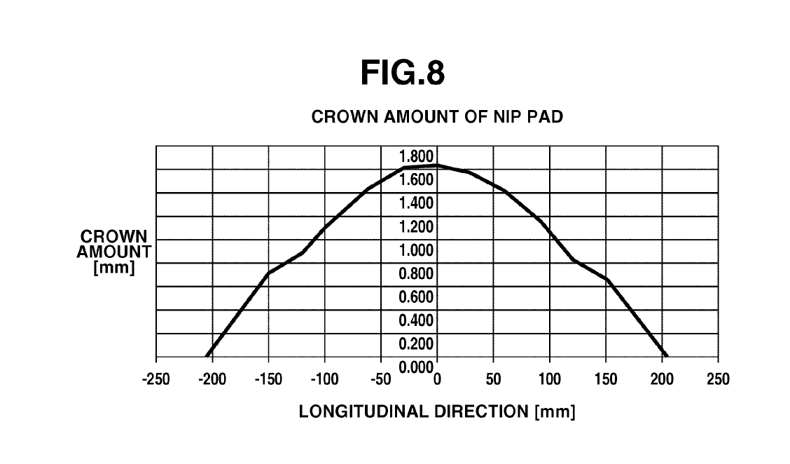

The pad 43 is a crown shaped pad as illustrated in FIG. 8 to correct a deflection in a pressed state. Specifically, the pad 43 has a normal crown shape in which a central part is larger than end portions in the longitudinal direction perpendicular to the conveying direction of the recording material P. The normal crown amount is, between the center and the end portion (the position 200 mm from the center) in the longitudinal direction of the pad 43, within the range from 1.4 mm to 1.8 mm, and most preferably, 1.6 mm.

At the upper surface side (the coil unit 60 side) of the stay 42, a magnetic core 44 (inner magnetic core) 44 for concentrating the induction magnetic field onto the fixing belt 41 to effectively heat the fixing belt 41 is provided along the longitudinal direction of the stay 42.

The both left and right end portions of the stay protrude outward from the both left and right end portions of the fixing belt 41 respectively. To the both left and right end portions, flange members 45L and 45R of a symmetrical shape are fitted respectively. The fixing belt 41 is externally fit in a loose condition to a complex of the stay 42, the pad 43, and the core 44. The movement in the longitudinal direction (the left and right direction) of the fixing belt 41 is restricted by the inward surfaces of the flange members 45L and 45R.

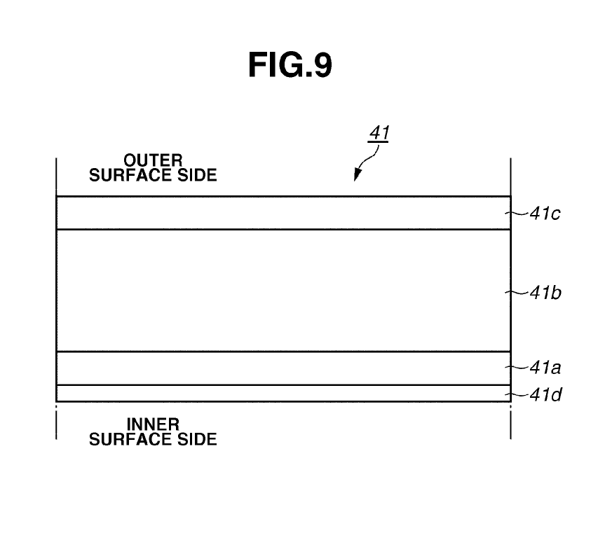

The fixing belt 41 includes, as will be described below, a base layer 41a (FIG. 9) formed of a metal that generates heat by electromagnetic induction. Consequently, as the members for restricting movement to the width direction of the fixing belt 41 in a rotating state, the flange members 45L and 45R only need to include flange portions for simply receiving the end portions of the fixing belt 41. The arrangement is advantageous to simplify the structure of the fixing device 500.

At a central portion of the pad 43 in a longitudinal, a temperature sensor TH such as a thermistor serving as a temperature detection unit (temperature detection element) for detecting a temperature of the fixing belt 41 is provided via an elastic supporting member 46. The sensor TH elastically contacts the inner surface of the fixing belt 41 by a member 46. The arrangement enables the sensor TH to follow position variation due to, for example, wavy movement of the sensor contact portion of the rotating fixing belt 41, and thereby the good contact state with the inner surface of the fixing belt 41 can be maintained.

The assembly 40 has the left and right flange members 45L and 45R between the left and right side plates 30L and 30R. The left and right flange members 45L and 45R are engaged with vertical guide slit portions 31 provided in the side plates 30L and 30R respectively. The arrangement enables the assembly 40 to have a degree of freedom capable of moving in the vertical direction along the slit portions 31 between the left and right side plates 30L and 30R.

FIG. 9 is a model illustrating a layer structure of the fixing belt 41. In the exemplary embodiment, the inner diameter of the fixing belt 41 is 30 mm, and the fixing belt 41 includes the nickel base layer (magnetic member, and metallic layer) 41a formed by electro-forming. A thickness of the base layer 41a is 40 μm. On the outer periphery of the base layer 41a, a heat-resistant silicone rubber layer is provided as an elastic layer 41b. Preferably, the thickness of the layer 41b is set within the range from 100 to 1000 μm.

In the exemplary embodiment, the thickness of the layer 41b is set to 300 μm to reduce worm-up time by decreasing a heat capacity of the belt 41, and obtain a good fixed image in fixation of a color image. The silicone rubber forming the layer 41b has a hardness of JIS-A20°, and a thermal conductivity is 0.8 W/mK. On the outer periphery of the layer 41b, as a surface release layer 41c, a fluororesin layer (for example, PFA or PTFE) of a thickness of 30 μm is provided.

On the inner surface side of the base layer 41a, to reduce a sliding friction between the inside of the belt and the sensor TH1, a resin layer (lubricative layer) 41d having a thickness of 10 to 50 μm (for example, a fluororesin layer or a polyimide layer) can be provided. In this exemplary embodiment, as the layer 41d, a polyimide layer of 20 μm is provided.

A heat capacity of the entire fixing belt 41 is low, and the fixing belt 41 has flexibility (elasticity). In a free state, the fixing belt 41 maintains the cylindrical shape. For the metal layer 41a of the fixing belt 41, instead of nickel, a metal such as ferrous metal, copper, and silver can be appropriately selected. On the resin base layer, layers of such metals can be laminated. The thickness of the metal layer 41a can be adjusted depending on a frequency of a high frequency current to be applied to an exciting coil (magnetic field generation coil) 62 in the unit 60, which will be described below, and the magnetic permeability and conductivity of the metal layer 41a. Preferably, the thickness is to be set to a thickness between 5 to 200 μm.

### (2-2) Pressure Roller 50

The pressure roller 50 is rotatably provided under the heating assembly 40 between the left and right side plates 30L and 30R via bearings 51 substantially in parallel with the longitudinal direction of the heating assembly 40 in the axis direction.

In this exemplary embodiment, the roller 50 is an elastic roller having an outer diameter of 30 mm formed by providing a silicone rubber layer as an elastic layer 50b around a core bar 50a of ferrous metal. The core bar 50a has a diameter of 20 mm at the center portion and a diameter of 19 mm at the both end portions in the longitudinal direction. As a surface release layer 50c, a fluororesin layer (for example, PFA or PTFE) of a thickness of 30 μm is provided. The hardness of the pressure roller 50 at the center portion in the longitudinal direction is ASK-C70° C. The core bar 50a is tapered to obtain a uniform pressure in the longitudinal direction at the fixing nip portion N even when the pad 43 bends in a pressed state. The fixing nip portion is formed by a press-contact of the fixing belt 41 and the pressure roller 50.

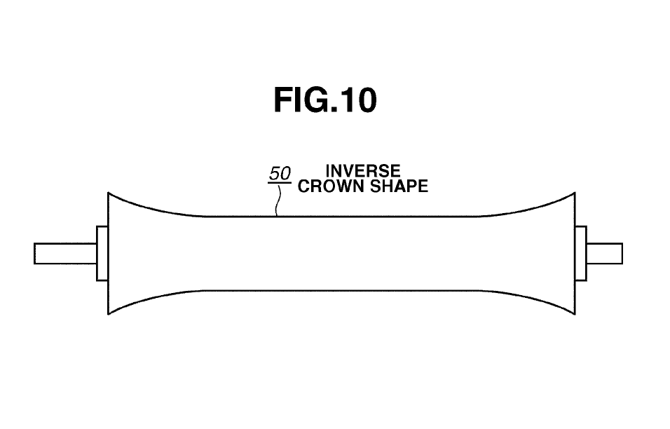

The outside diameter shape of the pressure roller 50 is, as illustrated in the schematic view in FIG. 10, a so-called reverse crown shape having a larger outside diameter at the both end portions as compared to that at the center position in the longitudinal direction perpendicular to the conveyance direction of the recording material P. The reverse crown amount is, between the center and the end portion (the position 163.5 mm from the center) of the roller 50, within the range from 150 to 250 μm, and most preferably, 200 μm.

At the right side end portion of the core bar 50a, a pressure roller drive gear 52 is fixed. To the gear 52, driving force of a fixing motor 53 controlled by a control unit 309 is transmitted via a transmission unit (not illustrated), and thereby the pressure roller 50 is driven and rotated at a predetermined speed in the counterclockwise direction indicated by the arrow in FIG. 6.

### (2-3) Pressure Mechanism 80

In this exemplary embodiment, the pressure mechanism 80 is a mechanism (pressure mechanism) for pressing the pad 43 of the heating assembly 40 against the pressure roller 50 via the fixing belt 41 at a predetermined pressure to form the predetermined nip portion N between the fixing belt 41 and the pressure roller 50. In this exemplary embodiment, the pressure to be applied to the pressure mechanism 80 can be changed by a pressure changing mechanism.

To upper parts of the left and right side plates 30L and 30R, a pair of pressure levers 81L and 81R longer in the front-back direction is symmetrically provided respectively as pressure members.

The pressure lever 81L of the left side is located at the upper side of a portion 45a to be pressed of the left flange member 45L. At a back side from the left flange member 45L, the rear edge portion of the pressure lever 81L is pivotally attached to the left side plate 30L in a state rotatable in the vertical direction about an axis 81a. The front end portion of the lever 81L is located at the front side from the left flange member 45L. The lever 81 L is always rotate-urged downward about the axis 81a by a force of a spring of a screw 82L. The spring is provided as an urging member between the lever 81 and the side plate 30L.

The pressure lever 81R of the right side is located at the upper side of the portion 45a to be pressed of the right flange member 45R. At a back side from the right flange member 45R, the rear edge portion of the pressure lever 81R is pivotally attached to the right side plate 30R in a state rotatable in the vertical direction about the axis 81a. The front end portion of the lever 81R is located at the front side from the right flange member 45R. The lever 81R is always rotate-urged downward about the axis 81a by the force of a spring of a screw 82R. The spring is provided as a pressure mechanism between the lever 81R and the side plate 30R.

In a free state, the lower surfaces of the left and right pressure levers 81L and 81R are pressed against the upper surface of the portions 45a to be pressed of the left and right flange members 45L and 45R respectively by a predetermined spring force by the spring 82a of the screw equipped with the spring. With the structure, in the heating assembly 40, the stay 42 and the pad 43 are pressed downward together with the left and right flange members 45L and 45R and thereby the pad 43 presses and contacts the pressure roller 50 across the fixing belt 41 against the elasticity of the elastic layer 50b.

The press-contact forms the nip portion N of a predetermined width between the fixing belt 41 and the pressure roller 50 with respect to the recording material conveyance direction a. The pad 43 assists the formation of the pressure profile of the nip portion N.

Between the left and right side plates 30L and 30R, via bearings 83, a camshaft 84 is rotatably provided. To the left and right end portions of the shaft 84, on the outside of the end portions, eccentric cams (pressure variable cams) 85L and 85R of the same shape are symmetrically fixed in the same phase. The left eccentric cam 85L is located at the lower side of the front end portion of the left pressure lever 81L. The right eccentric cam 85R is located at the lower side of the front end portion of the right pressure lever 81R.

At the left side end portion of the shaft 84, a camshaft drive gear 86 is fixed. To the gear 86, driving force of a camshaft motor (for example, stepping motor) 87 controlled by the control unit 309 is transmitted via a transmission unit (not illustrated), and thereby rotary drive control of the shaft 84, that is, the left and right eccentric cams 85L and 85R is performed. The rotary drive control of the eccentric cams 85L and 85R lifts and rotates the left and right pressure levers 81L and 81R against the spring force of the screw 82L equipped with the spring to change the pressure of the pad 43 to the pressure roller 50.

The above-described bearings 83, the camshaft 84, the eccentric cams 85L and 85R, the gear 86, the motor 87 also function as the pressure changing mechanism for changing the pressure at the nip portion N by the pressure mechanism 80. The pressure changing control by the pressure changing mechanism will be described below.

### (2-4) Coil Unit 60

The coil unit 60 is a heat source (induction heating unit) for heating the fixing belt 41 by induction heating. The unit 60 is, at the upper surface side of the heating assembly 40, that is, at the side opposite by about 180° to the roller 50 side of the heating assembly 40, fixed to the left and right side plates 30L and 30R. The unit 60 includes the exciting coil (coil for generating magnetic flux) 62, and the magnetic core 63 being assembled to a housing 61 along the fixing belt 41.

The housing 61 is a heat-resistant molded resin (molded member of an electric insulating resin) of an oblong box shape in which the horizontal direction is long. At the side of a bottom plate 61 of the housing 61, the housing 61 faces the fixing belt 41. A bottom plate 61a curves inward along a substantially semicircle portion of the outer periphery of the fixing belt 41 in the cross section. The housing 61 is opened at the opposite side of the bottom plate 61a. The housing 61 faces the upper surface of the fixing belt 41 at the bottom plate 61a side with a predetermined gap (space) α, and is fixed to the left and right side plates 30L and 30R at the left and right end portions with brackets 66.

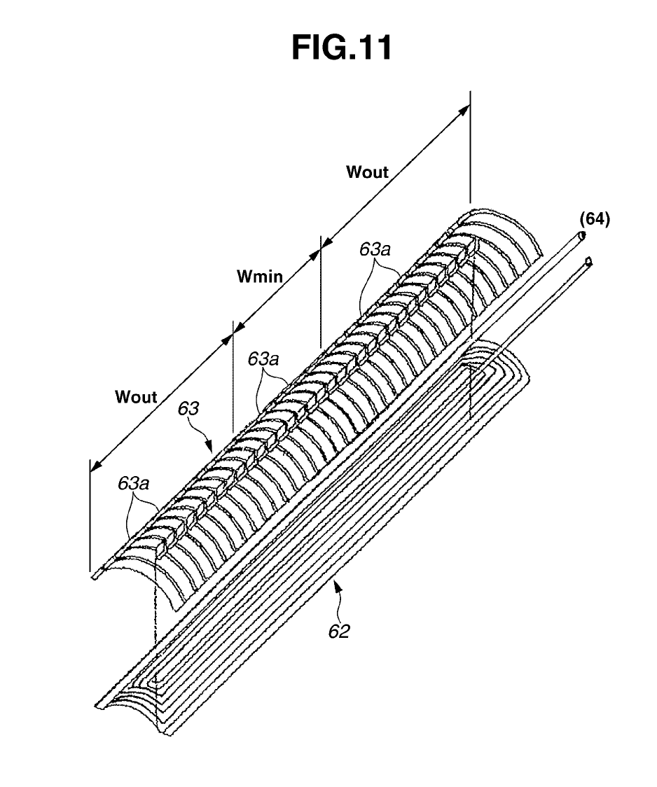

The wire employed for the coil 62 includes, for example, a litz wire. As illustrated in FIG. 11, the wire is formed in an oblong and ship bottom shape, and wound to face a part of the periphery and the side plate of the fixing belt 41. The coil 62 is disposed on the inner surface of the bottom plate 61a curving inward to the housing and thus the coil 62 is provided within the housing. To the coil 62, a high-frequency electric current of 20 to 50 kHz is applied from a power-supply device (exciting circuit) 64 being controlled by the control unit 309.

The fixing belt 41 and the coil 62 maintain an electric insulating state by a mold of 0.5 mm, and are uniformly spaced at 1.5 mm (the distance between the mold surface and the belt surface is 1.0 mm). The belt 41 is uniformly heated.

The core 63 is an outside magnetic material core covering the coil 62 such that the magnetic field generated by the coil 62 substantially does not leak out except the metal layer (conductive layer) of the fixing belt 41. The core 63 is arranged along the longitudinal direction of the fixing belt 41, and divided into a plurality of parts and arranged in the direction perpendicular to a recording material conveyance direction a. The core 63 surrounds the wound central portion and the periphery of the coil 62.

In other words, assuming that the direction perpendicular to the recording material conveyance direction a is the longitudinal direction, the core 63 is arranged along the longitudinal direction of the fixing belt 41. Further, as illustrated in FIG. 11, the core 63 is divided into a plurality of parts in the longitudinal direction such that the core 63 can avoid temperature rise in a non-paper passing area in a case where various sizes of recording materials, for example, a postcard, and small recording materials of A5, B4, A4, A3, and A3 plus are passed. The core 63 includes divided movable cores 63a. The cores 63a can individually move in a direction of changing the distance from the belt 41.

The core 63 includes a core moving unit (core moving mechanism) 65 controlled by the control unit 309. The core moving unit 65 moves the individual cores 63a to a first distance position D (FIG. 6) close to the fixing belt at a predetermined distance, and a second distance position E (FIG. 7) farther away from the fixing belt 41 than the position D. To simplify the drawing, the specific structure of the core moving unit 65 is omitted, however, the core moving unit described in Japanese Patent Application Laid-Open No. 2011-053597 can be applied to the exemplary embodiment. In this exemplary embodiment, the first distance position D is a home position of the cores 63a.

In this exemplary embodiment, the width dimension (including a space dimension to an adjacent core) of the core 63a in the direction perpendicular to the recording material conveyance direction a is 10 mm. In the device 500 according to the exemplary embodiment, the cores 63a corresponding to a minimum width area Wmin corresponding to a minimum width size recording material, capable of passing through the device 500 are not necessary to move, and the cores are located at the first distance position D and fixed to the housing 61. Movement of the individual cores 63a in an area Wout other than the above-described width area Wmin is controlled by the core movement unit 65 to the first distance position D or the second distance position E.

The cores 63a effectively guide alternating current magnetic flux generated by the coil 62 to the fixing belt 41. In other words, the cores 63a are used to increase the efficiency of the magnetic circuit (magnetic path) and shield the magnetism. The material for forming the core 63a preferably has a high magnetic permeability and low residual magnetic flux density such as ferrite.

Movement of the cores 63a in the area corresponding to the non-paper passing portion is controlled from the first distance position D to the second distance position E when a recording material having a narrower width size than a maximum width size capable of passing through the device is fed into the device. As a result, the magnetic flux density is reduced in the area corresponding to the non-paper passing portion of the belt 41, and temperature rise can be suppressed in the non-paper passing portion.

### (2-5) Magnetic Flux Shielding Plate and Shift Mechanism of the Plate

The magnetic flux shielding plates 10L and 10R are members, in an area where a magnetic field is generated between the coil 62 of the unit 60 and the fixing belt 41, for reducing the magnetic flux acting from the coil 62 to the fixing belt 41. In other words, in the width direction perpendicular to the recording material conveyance direction, the plates serve as a magnetic flux adjustment unit. The plates are moved to adjustment positions for adjusting the magnetic flux acting on the non-sheet passing portion of the belt 41 by reducing the magnetic flux when a recording medium of a width narrower than the passable maximum size is fed.

The positions of magnetic flux shielding plates 10L and 10R are moved and controlled by the shift mechanism that functions as a magnetic flux shielding member moving unit. In other words, the magnetic flux shielding plates 10L and 10R are moved to inoperative positions (home positions) where the magnetic field does not exist, and operative positions for reducing a temperature in the non-paper passing portions when a small recording material of a width narrower than a passable maximum width of the device 500 of a large recording material is fed.

The material for the magnetic flux shielding plates 10L and 10R can be non-magnetic metal such as aluminum, copper, silver, gold or brass or its alloy or can also be a high-permeability material such as ferrite or permalloy. In this exemplary embodiment, a copper plate is employed. The magnetic flux shielding plates 10L and 10R can be arranged between the coil 62 and the cores 63a, between the coil 62 and the fixing belt 41, or between the fixing belt 41 and the core 44.

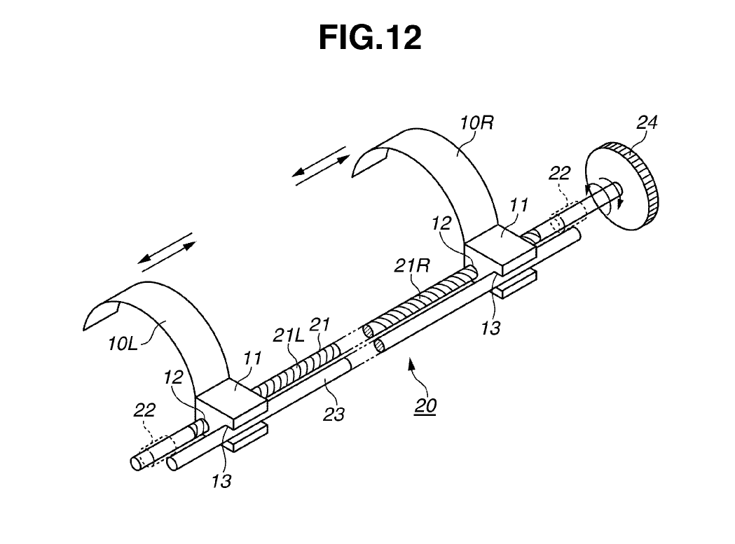

In the fixing device 500 according to the exemplary embodiment, a pair of the magnetic flux shielding plates 10L and 10R is arranged in a space a formed between the heating assembly 40 and the fixing belt 41 at the left and right both end portion sides. FIG. 12 is an external perspective view illustrating the pair of left and right magnetic flux shielding plates 10L and 10R and the shift mechanism 20 which is partially omitted.

In this exemplary embodiment, each of the pair of the plates 10L and 10R is a member of a copper metal strip curved in a substantially semi-arch shape to fit along a substantially semicircle portion of the outer periphery of the fixing belt 41. To each of the base portion (carriage) 11 of the plates 10L and 10R, a screw hole 12 and a recessed portion 13 to be guided are provided. Between the left and right side plates 30L and 30R in the device chassis 30, via bearings 22, a screw shaft 21 is rotatably provided. The screw shaft 21 is formed such that a screw portion 21L of the left half portion side and a screw portion 21R of the right half portion are in an inverse screw relationship. Further, a guide shaft 23 is provided in parallel with the shaft 21 between the left and right side plates 30L and 30R.

The left plate 10L is provided at the left side of the fixing belt 41 by screwing the screw hole 12 of the base portion 11 with the screw portion 21L of the left half portion side of the shaft 21, and engaging the recessed portion 13 with the shaft 23 in the space a between the assembly 40 and the fixing belt 41. The right plate 10R is provided at the right side of the fixing belt 41 by screwing the screw hole 12 of the base portion 11 with the screw portion 21R of the right half portion side of the shaft 21, and engaging the recessed portion 13 with the guide shaft 23 in the space a between the assembly 40 and the fixing belt 41.

At the right side end portion of the shaft 21, a screw shaft drive gear 24 is fixed. To the gear 24, driving force of a screw shaft drive motor (for example, stepping motor) 25 controlled by the control unit 309 is transmitted via a transmission unit (not illustrated), and thereby normal and reverse rotary drive control of the shaft 21 is performed. The left and right plates 10L and 10R are set to a predetermined position at the left end portion side and a predetermined position at the right end portion side as the home positions, i.e., the inoperative positions, respectively.

In a state where the left and right plates 10L and 10R are positioned at the home positions, normal rotary driving of the shaft 21 by the motor 24 moves the left and right plates 10L and 10R toward the center portion of the fixing belt 41 with the same amount of movement respectively, and thereby the distance between the plates is narrowed with the center as reference. By controlling the amount of normal rotation of the shaft 21, the plates 10L and 10R are moved to the operative positions for reducing a temperature in the non-paper passing portions in passing a small recording material of a width narrower than a passable maximum width of the device 500 of a large recording material. The movement of the left and right plates 10L and 10R is performed in a noncontact manner with respect to the fixing belt 41 and the bottom plate 61a of the housing 61 within the space α.

In a state where the distance between the left and right plates 10L and 10R is being narrowed, reverse rotary driving of the shaft 21 by the motor 25 moves the left and right plates 10L and 10R toward the home positions of the left and right both end portion sides of the fixing belt 41 with the same amount of movement respectively. In other words, the distance between the left and right plates 10L and 10R is widened with the center as reference. The movement of the left and right plates 10L and 10R is performed in a noncontact manner with respect to the fixing belt 41 and the bottom plate 61a of the housing 61 within the space α.

The above-described members 21 to 24 constitute the shift mechanism 20 serving as the magnetic flux shielding member moving unit for moving the left and right plates 10L and 10R to the inoperative positions and the operative positions. The insertion of the left and right plates 10L and 10R is more effective for reducing a heat quantity of the fixing belt 41 and the power of the magnetic flux, than the movement of the cores 63a. Further, the cooperative movement of the cores 63a and the movement mechanism 65 enables the control of the longitudinal heat generation distribution in a width narrower than the divided width of the core 63a. The thickness of the left and right plates 10L and 10R is 0.5 mm, which is the thickness equal to the thickness of the surface or more.

As described above, the left and right plates 10L and 10R are arranged at the both end portions of the fixing belt 41 in the longitudinal direction. The longitudinal width (the width perpendicular to the recording material conveyance direction) of the left and right plates 10L and 10R arranged to the end portions is, preferably, wide enough to achieve the magnetic flux shielding effect. Further, it is preferable that the width is set to a width not narrowing a maximum heat generation width corresponding to a recording material of a maximum size. Further, it is preferable that the width can be arranged without widening the longitudinal width of the device 500. Specifically, in this exemplary embodiment, the width is set to 20 mm.

### (2) Fixing Operation

In a standby state of the image forming apparatus, in the fixing device 500, the fixing motor 53 is turned off, and the rotation of the pressure roller 50 is stopped. The pressure mechanism 80 has been set to a pressure release state, and the pressure at the nip portion N has been released. The power supply to the coil 62 in the coil unit 60 has been turned off. The left and right magnetic field shielding plates 10L and 10R have been set to the home positions that are the inoperative positions.

The control unit (controller) 309 sets the pressure mechanism 80 to a pressing state at a predetermined control timing based on an input of a print job start signal (image formation job start signal). As a result, the nip portion N enters the pressing state. Further, the motor 53 is turned on. By the operation, the roller 50 is driven and rotated in the counterclockwise direction indicated by the arrow in FIG. 6 at a predetermined speed.

The rotation of the pressure roller 50 transmits the driving force (frictional force) to the fixing belt 41 via the nip portion N, and thereby the fixing belt 41 is driven and rotated. The inner surface of the fixing belt 41 closely contacts the lower surface of the pad 43, and while sliding, the fixing belt 41 is driven and rotated around the outside circumference of the stay 42, the pad 43, and the core 44 in the clockwise direction indicated by the arrow at the same speed as the rotation speed of the roller 50. The movement in the thrust direction due to the rotation of the fixing belt 41 is restricted by the flange portions of the left and right flange members 45L and 45R.

At least during image formation execution, the roller 50 is driven and rotated by the motor 53 under the control of the control unit 309, and thereby the fixing belt 41 is driven and rotated as described above. The rotation is performed at a substantially the same peripheral speed as the conveyance speed of the recording material P that is bearing an unfixed toner image t conveyed from the secondary transfer unit T2 side. In this exemplary embodiment, the fixing belt 41 rotates at the surface rotational speed of 300 mm/sec, and is capable of fixing a full-color image on 80 sheets per minute for A4-sized recording material and 58 sheets per minute for A4R-sized recording material.

The control unit 309 supplies, from the power-supply device 64 to the coil 62, for example, an alternating current (high-frequency electric current) of 20 kHz to 500 kHz. With the supply of the alternating current, the coil 62 generates alternating magnetic flux (magnetic field). The alternating magnetic flux is guided to the metal layer 41a of the fixing belt 41 at the upper surface side of the fixing belt 41 being rotated by the core 63. Then, an eddy current is generated in the metal layer 41a, and due to Joule heat caused by the eddy current, the metal layer 41a generates heat by itself (electromagnetic induction heating) and the temperature of the belt 41 increases.

In other words, when the rotating fixing belt 41 passes through an area where the magnetic field generated from the unit 60 exists, the metal layer 41a generates heat by the electromagnetic induction heating, and thereby the entire periphery of the fixing belt 41 is heated and the temperature increases. In this exemplary embodiment, the fixing belt 41 and the coil 62 of the unit 60 maintain an electric insulating state with the housing bottom plate (mold) 61a having the thickness of 0.5 mm. The fixing belt 41 and the coil 62 are uniformly spaced at 1.5 mm (the distance (the space α) between the surface of the base plate 61a and the belt surface is 1.0 mm), and the fixing belt 41 is uniformly heated.

The temperature of the fixing belt 41 is detected by the temperature sensor TH. The sensor TH detects a temperature of a portion used as a paper passing area on the fixing belt 41, and the detected temperature information is fed back to the control unit 309. The control unit (temperature control unit) 309 controls the power supply from the power-supply device 64 to the coil 62 such that the detected temperature (information about the detected temperature) input from the sensor TH is maintained at a predetermined target temperature (fixing temperature: information corresponding to a predetermined temperature).

In other words, when the detected temperature of the fixing belt 41 increases to the predetermined temperature, the power supply to the coil 62 is cut off. In this exemplary embodiment, the temperature adjustment is performed to maintain the temperature of the fixing belt 41 at a target temperature of 180° C. by varying the frequency of the high-frequency electric current based on a detection value of the sensor TH to control the electric power to be input to the coil 62.

In a state where the roller 50 is driven and the temperature of the fixing belt 41 is increased and adjusted to the predetermined fixing temperature as described above, the recording material P having an unfixed toner image t is fed into the nip portion N while being guided by the guide member 33 with the toner image bearing surface facing toward the fixing belt 41 side. The recording material P closely contacts the outer periphery of the fixing belt 41 at the nip portion N, and is supported and conveyed together with the fixing belt 41 in the nip portion N.

As a result, the unfixed toner image t is heated mainly by the heat of the fixing belt 41 while being pressed by the nip portion N, and fixed on the surface of the recording material P. The recording material P passed through the nip portion N separates by itself (curvature separation) from the outer periphery of the fixing belt 41 due to a deformed exit portion of the nip portion N, and the recording material P is conveyed out of the fixing device.

Since the unit 60 is arranged outside of the fixing belt 41 that is heated to high temperatures, instead of inside of the fixing belt 41, the coil 62 is hard to rise to high temperatures, and the electrical resistance is also hard to increase. Consequently, even if a high-frequency electric current is applied, loss due to Joule heat can be reduced. Further, the arrangement of the coil 62 at the outside of the fixing belt 41 contributes to the reduction in the diameter (reduction in heat capacity) of the fixing belt 41, and energy can be satisfactorily saved.

With respect to the warm-up time of the fixing device 500 in this embodiment, the heat capacity is very low and therefore, for example, when 1200 W is input to the coil 62, the temperature of the fixing belt 41 reaches 180° C., which is a target temperature, in about 15 seconds. As a result, heating operation during stand-by becomes unnecessary, and thereby an amount of electric power consumption can be suppressed to a low level.

### (2-7) Control of Temperature Rise Phenomenon

In FIG. 3A, Wmax is a width size (passing area of recording material) of a maximum width recording material usable in the fixing device 500. In this exemplary embodiment, the large size recording material is a 13 by 19 inch paper, and fed in longitudinal feed. Consequently, the length of Wmax is 13 inches (330 mm).

In this exemplary embodiment, the width (longitudinal size) of the fixing belt 41 is 390 mm, and the width of the pressure roller 50 is 370 mm. An effective heating width of the coil unit 60 for heating the fixing belt 41 is set to cover the maximum paper-passing width Wmax (330 mm).

Since the width (390 mm) of the fixing belt 41 is wider than the maximum paper-passing width Wmax (330 mm), at each of the left and right outside portions of the maximum paper-passing width Wmax of the fixing belt 41, an extended width portion of 30 mm is provided. The left and right extended width portions of the fixing belt 41 are the home positions of the left and right plates 10L and 10R (width of 20 mm) as the inoperative positions described above.

An area A is a paper-passing area of a small recording material (a width wider than a width area Wmin (FIG. 11) corresponding to a smallest width size recording material usable in the device 500) having a width narrower than Wmax. In the fixing device 500 in this exemplary embodiment, the conveyance of the recording material P is performed with the center as reference. A line Q is the center reference line (virtual line). Areas B are non-paper passing areas on the fixing belt 41 and the pressure roller 50 appearing when a small size recording material passes. In other words, each of the non-paper passing areas (areas at the both end portions in the longitudinal direction) is a difference area ((Wmax−A)/2) of the large size recording material passing area Wmax and the small size recording material passing area A, and appears at both sides of the passing area A.

Sequential feeding of the small size recording material causes heat generation in the non-passing areas B on the fixing belt 41, in a predetermined heat quantity per unit length similarly to the area corresponding to the passing area A even though the thermal energy is not consumed for heating the recording material P. This results in the accumulation of heat. As a result, in the parts on the fixing belt 41 corresponding to the non-passing areas B, the temperature increases to be higher than temperatures in the area corresponding to the passing area A, that is, a so-called temperature rise phenomenon occurs. Due to the temperature rise phenomenon of the fixing belt 41, the temperature in portions corresponding to the non-passing areas on the pressure roller 50 contacting the fixing belt 41, also increases to be higher than the portion corresponding to the passing area.

In order to increase the temperature of the heating member 41 at a high speed, if the thickness of the heating member 41 is reduced to reduce the heat capacity, the cross-sectional area of the heating member 41 in the cross-section perpendicular to the shaft becomes very small, and consequently, the thermal conduction in the shaft direction is not good. The tendency becomes significant as the thickness is reduced, and if a material having a low thermal conductivity such as a resin is employed, the thermal conductivity further decreases. This phenomenon can be clearly understood from the Fourier's law in which a heat quantity Q transferred per unit time is represented by Q=λ·f(θ1−θ2)/L where λ is the thermal conductivity, (θ1−θ2) is a temperature difference between two points and L is a length.

This problem can be ignored when a recording material of a substantially the same length in the longitudinal direction of the heating member 41, that is, a recording material (large size recording material) of the maximum width is fed and fixed. However, if a small recording material having a width narrower than this width is to be sequentially fed, the temperature in the non-passing areas of the heating member 41 increases to be higher than a temperature-adjustment temperature, and as a result, the temperature difference between the temperature in the passing area and the temperature in the non-passing area becomes very large (temperature rise phenomenon).

Consequently, due to the temperature rise phenomenon in the heating member 41, the heat-resistant life of peripheral members formed of the resin material can be reduced, or the device can be thermally damaged. Further, right after sequential feeding of a small size recording material, if a recording material of a width size wider than that of the small recording material is fed, due to partial uneven temperatures, wrinkles can be formed in the recording material, or uneven fixation can occur.

Such a temperature difference between the passing area and the non-passing area becomes larger as the heat capacity of the recording material to be conveyed becomes large and the throughput (the number of printed sheets per unit time) becomes high. For this reason, in a case where a heating device is formed using a heating member of thin and low heat capacity, the application of the subject matter to a copying machine of high throughput has been difficult.

In this exemplary embodiment, the temperature rise phenomenon in feeding a small size recording material is appropriately suppressed by performing the following two controls of a) and b).

a) Suppression of temperature rise phenomenon by movement control of divided movable cores 63a

As described above, the core 63 of the unit 60 is provided along the longitudinal direction of the fixing belt 41. The core 63 includes the divided movable cores 63a. The divided movable cores 63a are formed by dividing the core 63 into a plurality of cores in the longitudinal direction to avoid the temperature rise phenomenon in small size recording materials of various width sizes, and the cores 63a can be individually moved in a direction to change a distance to the belt 41. The divided movable cores 63a are controlled by the control unit 309. The core 63 includes the core movement mechanism 65 for moving the individual cores 63a.

The control unit 309, in a case where the recording material P to be fed into the device is a small size recording material, out of the plurality of divided movable cores 63a, moves the cores 63a corresponding to the passing area A of the small size recording material to be passed, to the first distance position D (FIG. 6). The control unit 309 controls the core movement mechanism 65 to set the other cores 63a to the second distance position E (FIG. 7).

In this exemplary embodiment, the individual cores 63a can be moved by the mechanism 65 to the first distance position D close to the fixing belt 41 at an interval of 0.5 mm, and to the second distance position E away from the fixing belt 41 at an interval of 10 mm. When the cores 63a are at the first distance position D, the heat generation efficiency in the portion of the fixing belt 41 corresponding to these cores is very high. On the contrary, when the cores 63a are at the second distance position E, the heat generation efficiency in the portion of the fixing belt 41 corresponding to these cores is decreased.

When a print job (fixing processing) is started, the control unit 309 reads an input value of the size of the recording material to be fed. If the recording material is a large size recording material, the control unit 309 controls the mechanism 65 to set the entire divided movable cores 63a to the first distance position D. If the recording material is a small size recording material, the control unit 309 controls the mechanism 65 to set the cores 63a corresponding to the passing area A of the small size recording material out of the entire cores 63a to the first distance position D, and to set the other cores 63a to the second distance position E.

As a result, the heat generation efficiency in the portions corresponding to the non-passing areas B of the belt 41 decreases to a level lower than that in the portion corresponding to the passing area A, and thereby the temperature rise phenomenon of the fixing belt 41 and the pressure roller 50 can be suppressed.

b) Suppression of temperature rise phenomenon by movement control of magnetic flux shielding plates When a print job is started, the control unit 309 reads an input value of the size of the recording material. If the recording material is a large size recording material, the control unit 309 maintains the left and right plates 10L and 10R at the home positions that are the inoperative positions. If the recording material is a small size recording material, the control unit 309 controls the driving unit 25 to drive the shaft 22 to rotate in the normal direction to move the left and right plates 10L and 10R in the direction toward the center portion of the fixing belt 41 respectively. The control unit 309 moves the left and right plates 10L and 10R to positions where the distance between the left and right plates 10L and 10R becomes a distance substantially corresponding to the width of the small size recording material, and stops the drive of the shaft 22.

By the movement of the left and right plates 10L and 10R in cooperation with the movement mechanism 65 of the cores 63a, the longitudinal heat generation distribution of the fixing belt 41 can be more finely controlled than the divided width of the core 63a, and thereby the temperature rise phenomenon in the fixing belt 41 and the pressure roller 50 is suppressed.

### (2-8) Pressure Changing Control

The pressure changing mechanism for changing the pressure at the nip portion N by the pressure mechanism 80 will be described. In this exemplary embodiment, the bearings 83, the camshaft 84, the eccentric cams 85L and 85R, the gear 86, the motor 87 serve as the pressure changing mechanism for changing the pressure at the nip portion N in the pressure mechanism 80. The operation of the pressure changing mechanism is controlled by the control unit (controller) 309. The mechanism is described in detail below.

Driving the motor 87 transmits the driving force under control of the control unit 309 to the gear 86 via a transmission unit (not illustrated) such as a drive transmission gear, and this rotates the shaft 84 to rotate the cams 85L and 85R in the same phase. The rotation angle of the cams 85L and 85R is controlled to move the left and right pressure levers 81L and 81R around the shaft 81a in the vertical direction in a certain movement to change the pressure in the nip portion N.

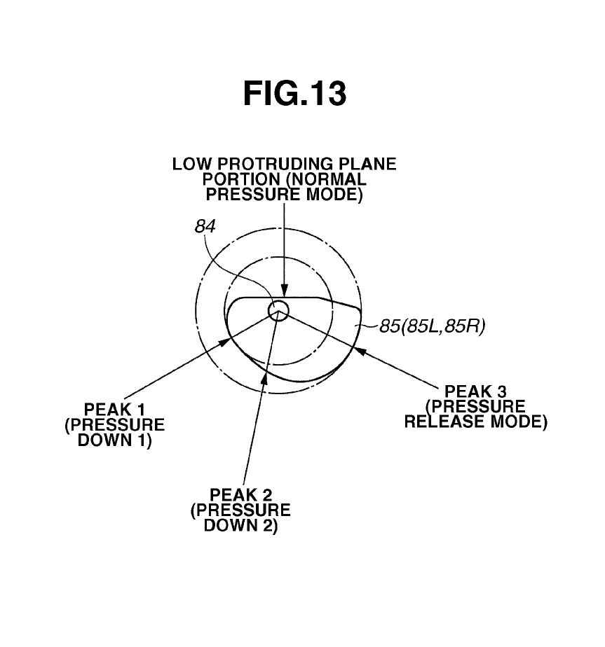

In this exemplary embodiment, the cams (85L and 85R) have, as a cam profile, as illustrated in FIG. 13, a low protruding plane portion, and three peak shapes of peaks 1, 2, and 3. The amounts of protrusion of the peaks 1, 2, and 3 are larger than that of the low protruding plane portion in this order. The low protruding plane portion serves as a normal pressure mode corresponding portion, the peak 1 serves as a portion corresponding to a pressure down mode 1, the peak 2 serves as a portion corresponding to a pressure down mode 2, and the peak 3 serves as a portion corresponding to a pressure release mode.

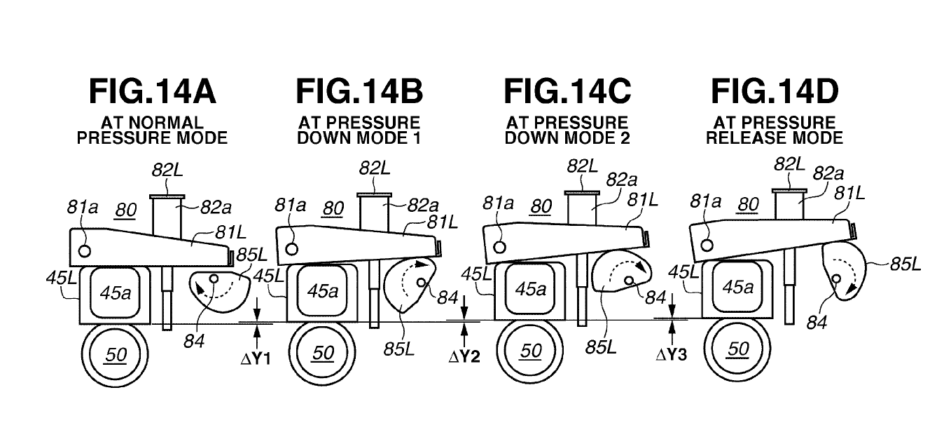

With reference to FIGS. 14A to 14D, the pressure changing control by the cams 85 is described. FIGS. 14A to 14D illustrate the pressure mechanism 80 of the left side. The pressure mechanism 80 of the right side symmetrically operates with the pressure mechanism 80 of the left side.

FIG. 14A illustrates a status of the mechanism in the normal pressure mode. In this status, the cam 85L is stopped at a rotation angle in which the low protruding plane portion faces upward, and the cam 85L is not in contact with the lower surface of the front end portion of the pressure lever 81L. Consequently, the lower surface of the pressure lever 81L is fully pressed to the upper surface of the portion 45a to be pressed of the flange member 45L with a predetermined spring force by the spring 82a of the screw provided with the spring 82L. Accordingly, the pressure in the nip portion N is set to a normal pressure (full pressure).

FIG. 14B illustrates a status of the mechanism in the pressure down mode 1. In this status, the cam 85L is stopped at a rotation angle in which the peak 1 faces upward, and the cam 85L lifts the pressure lever 81L by a predetermined amount against the spring force of the spring 82a of the screw provided with the spring 82L, to a position upper than the position in the normal pressure mode. Accordingly, the pressure to the flange member 45L is reduced to change the position of the flange member 45L upward by ΔY1, and thereby the pressure in the nip portion N is reduced to a level lower than the normal pressure by a predetermined amount.

FIG. 14C illustrates a status of the mechanism in the pressure down mode 2. In this status, the cam 85L is stopped at a rotation angle in which the peak 2 faces upward, and the cam 85L further lifts the pressure lever 81L by a predetermined amount against the spring force of the spring 82a of the screw provided with the spring 82L, to a position upper than the position in the pressure down mode 1. Accordingly, the pressure to the flange member 45L is further reduced to change the position of the flange member 45L upward by ΔY2, and thereby the pressure in the nip portion N is further reduced to a level lower than the pressure down mode 1 by a predetermined amount.

FIG. 14D illustrates a status of the mechanism in the pressure release mode. In this status, the cam 85L is stopped at a rotation angle in which the peak 3 faces upward, and the cam 85L further lifts the pressure lever 81L by a predetermined amount against the spring force of the spring 82a of the screw provided with the spring 82L to a position upper than the position in the pressure down mode 2. Accordingly, the active pressure to the flange member 45L is lost to change the position of the flange member 45L upward by ΔY3, and thereby the pressure in the nip portion N is substantially released. In a standby status of the image forming apparatus, the fixing device 500 is held in the pressure release status.

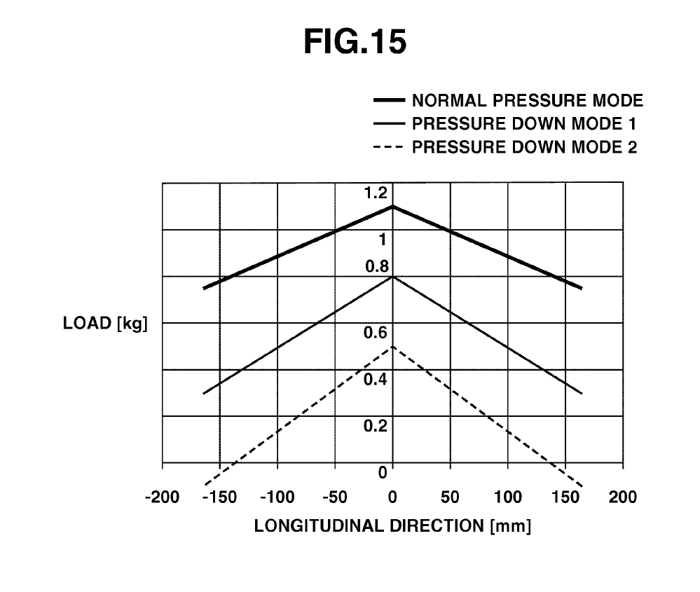

FIG. 15 illustrates pressure distribution in the normal pressure mode, the pressure down mode 1, and the pressure down mode 2 of the fixing device 500 in this exemplary embodiment. The pressure distribution was measured using the surface pressure measurement distribution system I-SCAN (manufactured by Nitta Corporation). The vertical line in FIG. 15 indicates the pressure obtained by integrating in a longitudinal width (the direction perpendicular to the paper conveyance direction) of a portion of 7 [mm] (the width of one sensor of I-SCAN) of paper (recording material) in the paper conveyance direction.

In the normal pressure mode, the pressure at the center portion was 1.1 [kg], and the pressure at the position of the endmost portion (165 mm) was 0.75 [kg]. In the pressure down mode 1, the pressure at the center portion was 0.8 [kg], and the pressure at the position of the endmost portion (165 mm) was 0.3 [kg]. In the pressure down mode 2, the pressure at the center portion was 0.5 [kg], and the pressure at the position of the endmost portion (165 mm) was 0 [kg].

In a case where an envelope of JIS Kaku #2 (width 240 mm×332 mm) was fed as the recording material P, in the normal pressure mode, the pressure value corresponding to the position of the center portion of the envelope was 1.1 [kg]. In contrast, a pressure value corresponding to the position of the end portion of the envelope was 0.85 [kg], that is, the pressure at the end portion was lower than that at the center portion by more than 0.2 [kg].

In this exemplary embodiment, the width in the rotation direction in the nip portion N between the fixing belt 41 and the pressure roller 50 was, when the nip pressure was 500 N, 8.5 mm in the center portion, and 8.0 mm in the end portion (the position 145 mm from the center).

The pressure was, 500 [N] in the normal pressure mode, 250 [N] in the pressure down mode 1, and 150 [N] in the pressure down mode 2.

In other words, when the pressure in the nip of the nip portion N in the conveyance direction of the recording material P is integrated, if a pressure corresponding to the center position in the width of the envelope to be fed is P1, and a pressure corresponding to the end portion is P2, the pressure difference (P1−P2) is more than 0.2 [kg].

### (2-9) Mechanism of Wrinkle Generation in Envelope

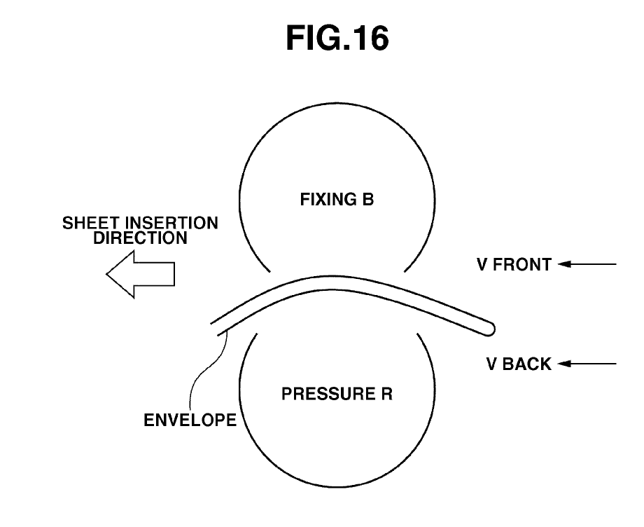

An envelope is formed by attaching two pieces (paper material at upper surface and lower surface) in a bag shape. If the feeding speeds of the two pieces (upper surface and lower surface) of the paper material are different, at the rear end in the nip portion seen in the envelope feeding direction, wrinkles can be generated. Factors causing the speed difference in the upper surface and the lower surface of the envelope within the nip portion N include, first, a difference in amounts of bending deformation, between the upper surface and the lower surface of the paper material in the nip portion (see FIG. 16).

A strong pressure at the both end portions of the envelope in the longitudinal direction (width direction) bends the envelope downward, and then, the deformation amounts of the paper material differ between the upper surface and the lower surface, and the feeding speeds of the paper material differ between the upper surface and the lower surface, and this causes wrinkles. To prevent the wrinkle generation, it is preferable to reduce the bending amounts in the upper surface and lower surface of the paper material. To achieve this, it is preferable to reduce the pressure at the both end portions of the envelope in the longitudinal direction (width direction).

Other than the envelope bending, the factors causing the speed difference in the upper surface and the lower surface of the envelope include actual rotation speed difference between the fixing belt 41 and the pressure roller 50. In such a case, the feeding speeds differ between the upper surface and the lower surface of the envelope. To prevent the wrinkle generation, in the fixing device, an individual drive source can be provided to each of the fixing belt 41 and the pressure roller 50 so that the fixing belt 41 and the pressure roller 50 can be controlled and driven to have substantially the same speed in the upper surface and the lower surface of the envelope. However, the additional individual drive sources increase the heat capacity of the entire fixing device, and this causes decrease in the energy saving capability.

As illustrated in FIG. 15, with respect to the pressure distribution of the fixing device 500 according to the exemplary embodiment in the longitudinal direction in the normal pressure mode, when recording materials of up to 13 inches in width size are fed, in order to increase the fixation at the both end portions of the recording materials, the pressure is applied to the both end portions. In such a state, if an envelope of a small width size is fed, due to strong pressure at the both end portions of the envelope, the envelope bends and tends to generate envelope wrinkles.

### (2-10) Prevention of Envelope Wrinkles

As described above, the fixing device 500 in this exemplary embodiment includes the pressure down modes 1 and 2 for reducing the pressure in the nip portion N. In the pressure down modes, as illustrated in FIG. 15, pressures at the farthest end portions in the longitudinal direction are lower than those in the normal pressure mode. Consequently, when an envelope having a narrow width is fed in the longitudinal direction, pressure at the both end portions of the envelope can be reduced, and thereby envelope wrinkle cannot be generated.

If an envelope having a wide width (large in width) is fed in the pressure down modes 1 and 2, the pressure at the both end portions of the envelope becomes too low, and the conveyance power at the both end portions of the envelope decreases much more than at the center portion. Therefore, the end portions of the envelope are both pulled toward the center portion, and wrinkles are generated. To solve this problem, depending on a width size of envelope, pressure in the nip is changed. In a case of a general recording material, which is not formed in a bag shape, there is no speed difference between the upper surface and the lower surface. For this reason, even if pressure at the both end portions is high, wrinkles are not generated.

In this exemplary embodiment, when an envelope is fed, pressure is changed depending on a width size in the longitudinal direction to prevent envelope wrinkle. In other words, in a case where a recording material to be fed into the fixing device 500 is an envelope, depending on the width of the envelope, the control unit 309 performs a control sequence for changing the pressure in the nip portion N.

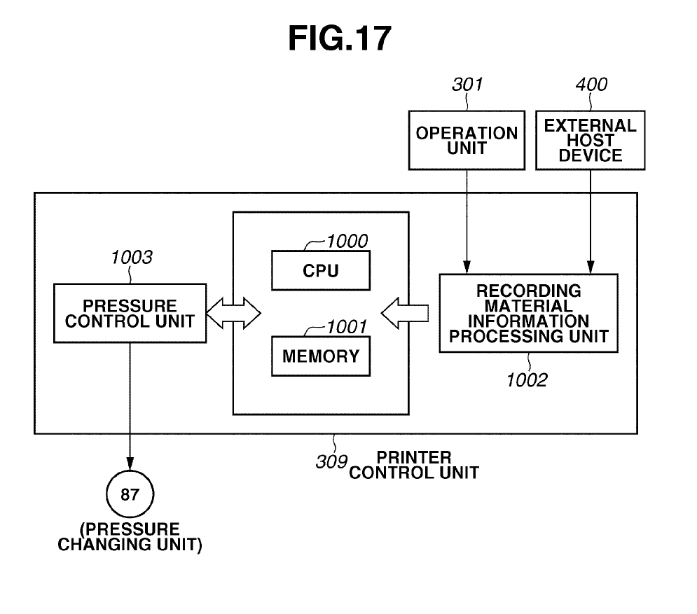

With reference to the block diagram of a control system illustrated in FIG. 17, the control according to the exemplary embodiment will be described. From an operation unit 301 or the external host device 400 such as a personal computer (PC), information (size and type) of the recording material to be output by a user is transmitted to a recording material information processing unit 1002, and the information in the recording material information processing unit 1002 is transferred to a central processing unit (CPU) 1000. The CPU 1000 refers to a memory 1001, and based on the information in the recording material information processing unit 1002, instructs a pressure control unit 1003 to set the pressure in the fixing device 500 to a predetermined value. The pressure control unit 1003 causes the motor 87 serving as the pressure changing mechanism to control the pressure in the nip portion N in the fixing device 500 to be at a predetermined level.

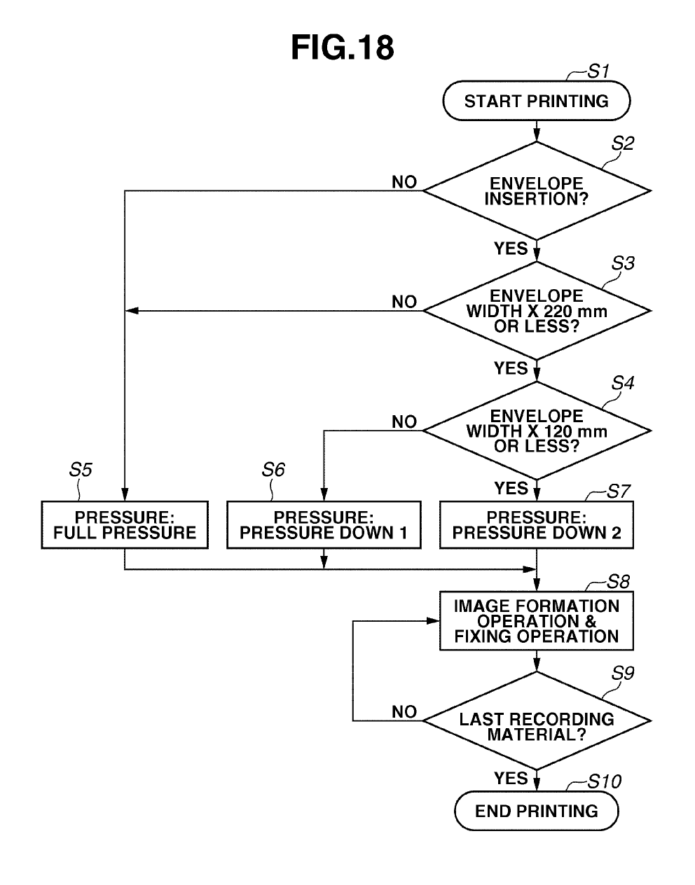

With reference to the flowchart illustrated in FIG. 18, a control flow by the control unit 309 will be described. In step S1, the control unit 309 in the image forming apparatus receives an image formation job. In step S2, the CPU 1000 in the control unit 309 determines whether the recording material P to be fed according to the image formation job is an envelope (envelope insertion). If the recording material to be fed is not an envelope (NO in step S2), in step S5, the control unit 309 sets the pressure to the normal pressure mode (full pressure), and starts the fixing device 500. In step S8, the control unit 309 instructs the fixing device 500 to perform the image formation operation and the fixing operation. In steps S9 and 10, when printing of the set number of sheets is completed, the printing operation ends. Then, the image forming apparatus is held in a standby state until a next image formation job is input.

In step S2, if the recording material to be fed is an envelope (YES in step S2), in step S3, the CPU 1000 determines whether the width of the envelope is 220 mm or less. If the width of the recording material to be fed is wider than 220 mm (NO in step S3), in step S5, the control unit 309 sets the pressure to the normal pressure mode (full pressure), and starts the fixing device 500. In step S8, the control unit 309 instructs the fixing device 500 to perform the image formation operation and the fixing operation.

If the width of the recording material to be fed is wider than 120 mm (NO in step S4) and equal to or less than 220 mm (YES in step S3), in step S6, the control unit 309 sets the pressure to the pressure down mode 1, and starts the fixing device 500. In step S8, the control unit 309 instructs the fixing device 500 to perform the image formation operation and the fixing operation.

If the width of the recording material to be fed is equal to or less than 120 mm (YES in step S4), in step S7, the control unit 309 sets the pressure to the pressure down mode 2, and starts the fixing device 500. In step S8, the control unit 309 instructs the fixing device 500 to perform the image formation operation and the fixing operation.

In other words, in the case where the recording material to be nipped and conveyed in the nip portion N is an envelope, the control unit 309 controls the pressure changing mechanisms 85L and 85R to change the pressure depending on whether the fixing processing (image heating processing) is to be performed on an envelope having a width wider than the predetermined width, or the fixing processing is to be performed on an envelope having a width equal to or less than the predetermined width. The control unit 309 controls the pressure to be reduced as the width of the envelope becomes narrower. In a case where the width of the envelope is 120 mm or less, the control unit 309 controls the pressure to be half of the normal pressure or less that is applied to recording materials other than envelopes (pressure down mode 2).

In other words, the control unit 309 controls the pressure depending on the width of the envelope subjected to image-heating processing.

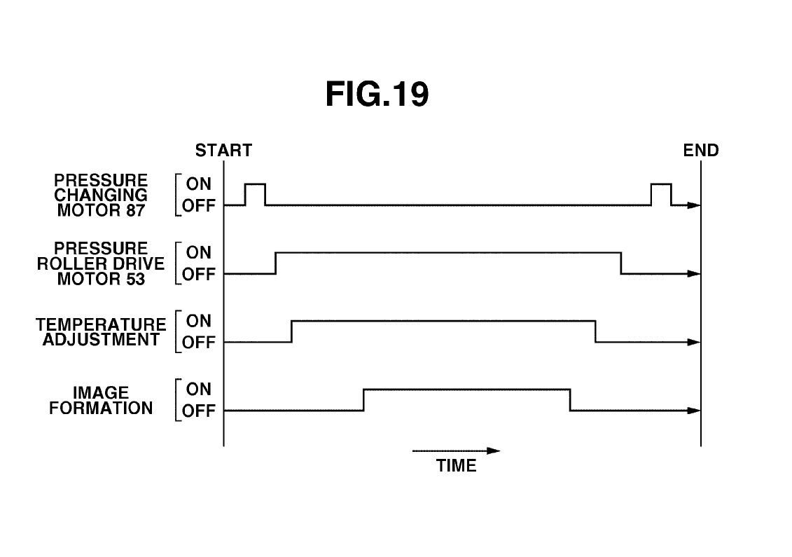

With reference to the timing chart illustrated in FIG. 19, the control according to the exemplary embodiment will be described. The control unit 309 drives the motor in the pressure changing mechanism to adjust the nip portion N in the fixing device 500 from a pressure release state to a predetermined pressure (the normal pressure mode, the pressure down mode 1, or the pressure down mode 2). Then, the control unit 309 drives the pressure roller 50 with the motor 53 to drive and rotate the pressure roller 50 and the fixing belt 41. The control unit 309 applies a voltage to the exciting coil 62 to heat the fixing belt 41 to adjust the temperature to a predetermined degree. Then, the control unit 309 starts image formation processing to form an image on the recording material, and outputs the image.

When the image formation processing ends, the control unit 309 stops the temperature adjustment, stops the drive of the pressure roller 50, and returns the nip portion N to the pressure release state.

Table 1 shows a result of verification experiment performed to verify whether wrinkles are generated in a rear end portion of an envelope in the feeding direction. The experiment was conducted under an atmosphere environment of 23° C. and 50%. An envelope of JIS Kaku #2 (240×332 mm) manufactured by YAMAZAKURA CO., LTD, an envelope of JIS Kaku #6 (162×229 mm) manufactured by YAMAZAKURA CO., LTD, and an envelope of JIS Naga #3 (120×235 mm) manufactured by YAMAZAKURA CO., LTD were used. Ten envelopes were fed sequentially, and if no wrinkles were generated out of 10 envelopes, ∘ was marked, and if wrinkles were generated in one or more envelopes, x was marked.

TABLE 1

| Envelope | Normal | Pressure down | Pressure down |
|---|---|---|---|
| size | pressure mode | mode 1 | mode 2 |
| Naga #3 | x | x | ∘ |
| Kaku #6 | x | ∘ | x |
| Kaku #2 | ∘ | x | x |

As shown in Table 1, depending on the widths of the envelopes, the pressure in the nip portion N was varied and the envelopes were fed. As a result, wrinkle generation in the envelopes was prevented. The envelope width and the pressure value which switch over the pressure can be appropriately changed to obtain an optimum result. Further, according to the width of the envelope, the pressure can be linearly changed.

As described above, the use of the fixing device 500 according to the exemplary embodiment can prevent wrinkle generation in a rear end portion of an envelope in the feeding direction.

In the first exemplary embodiment, depending on a width of an envelope, the pressure in the nip portion N in the fixing device 500 is controlled. In the second exemplary embodiment, in addition to the width of the envelope, a grammage of the envelope is used to control the pressure. An envelope having a large grammage has high stiffness, and is hard to bend within the nip portion N. For this reason, a difference between the feeding speeds in the upper and lower surfaces is small, and wrinkle rarely occurs.

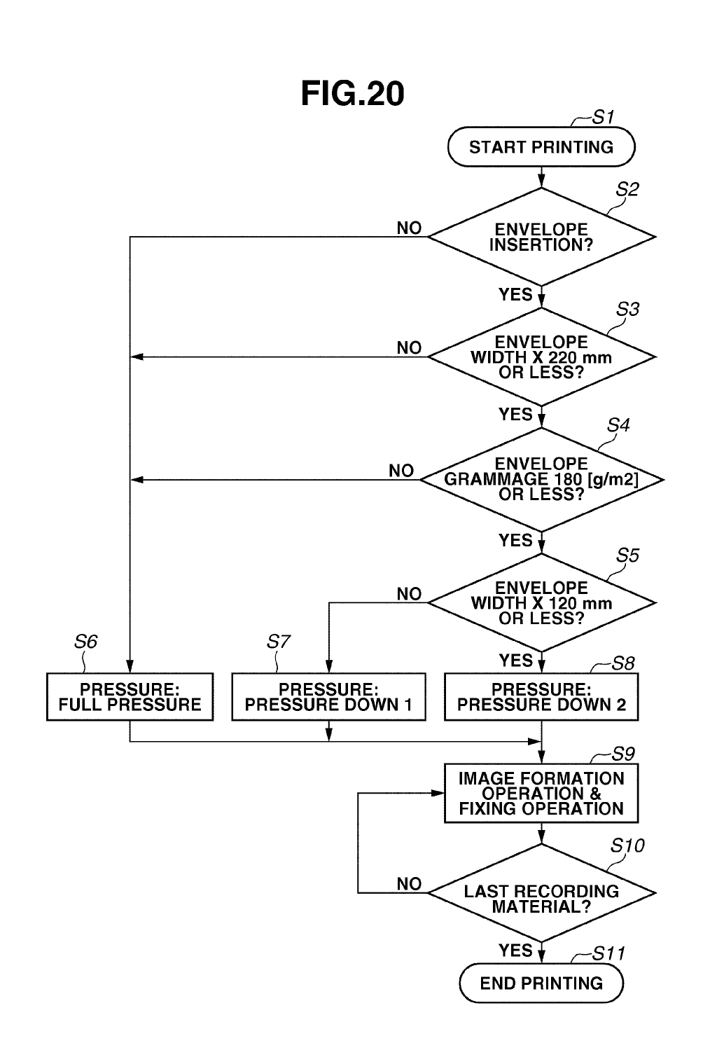

The block chart according to the exemplary embodiment is similar to that in the first exemplary embodiment, and consequently, the block chart is omitted. FIG. 20 is a flowchart according to the exemplary embodiment.

In step S1, the control unit 309 in the image forming apparatus receives an image formation job. In step S2, the CPU 1000 determines whether the recording material P to be used in the image formation is an envelope. If the recording material to be fed is not an envelope (NO in step S2), in step S6, the control unit 309 sets the pressure to the normal pressure mode (full pressure), and starts the fixing device 500. In step S9, the control unit 309 instructs the fixing device 500 to perform the image forming operation and the fixing operation. In steps S10 and 11, when printing of the set number of sheets is completed, the printing operation ends. Then, the image forming apparatus is held in a standby state until a next image formation job is input.

In step S2, if the recording material to be fed is an envelope (YES in step S2), in step S3, the CPU 1000 determines whether the width of the envelope is 220 mm or less. If the width of the recording material is wider than 220 mm (NO in step S3), in step S6, the control unit 309 sets the pressure to the normal pressure mode (full pressure), and starts the fixing device 500. In step S9, the control unit 309 instructs the fixing device 500 to perform the image formation operation and the fixing operation.

In step S4, if the grammage of the envelope to be fed is larger than 180 [g/m²] (NO in step S4), the stiffness is high, and the feed speed difference between the upper surface and the lower surface of the envelope rarely occurs. Consequently, in step S6, the control unit 309 sets the pressure to the normal pressure mode (full pressure) and starts the fixing device 500. In step S9, the control unit 309 performs the image forming operation and the fixing operation.

In step S4, if the grammage of the envelope to be fed is 180 [g/m²] or less (YES in step S4), depending on whether the width of the envelope is 120 [mm] or less, or wider than 120 [mm], the control unit 309 sets the pressure to the pressure down mode 1 or the pressure down mode 2. In step S7 or step S8, the control unit 309 starts the fixing device 500, and in step S9, performs the image forming operation and the fixing operation.

In other words, in a case where the grammage of the envelope is 180 [g/m²] or less, the control unit 309 controls the pressure to be lower than the normal pressure which is the pressure applied to recording materials other than envelopes. That is, in the case where the recording material nipped and conveyed in the nip portion N is an envelope, the control unit 309 controls the pressure changing mechanisms 85L and 85R to change the pressure depending on the grammage of the envelope.

When this exemplary embodiment is employed, in a case where a normal recording material other than envelopes and an envelope having a large grammage are to be sequentially fed, the time necessary for switching the pressure can be eliminated, and this increases the productivity of final products.

(1) Application of the image heating apparatus according to the present disclosure is, as described in the above exemplary embodiments, not limited to the fixing device for fixing an unfixed toner image formed on a recording material as a fixed image. For example, the image heating apparatus can be effectively applied to a gloss adding apparatus that re-heats and presses, or re-presses a toner image fixed on a recording material to increase glossiness of an image.

(2) The rotatable member contacting the image bearing surface of the recording material is not limited to the endless belt described in the exemplary embodiments. The rotatable member can have a roller shape.

(3) The opposite member facing the rotatable member contacting the image bearing surface of the recording material to form the nip portion can be, in addition to the rotatable roller member, a rotatable endless belt.

(4) The heating device for heating the rotatable member contacting the image bearing surface of the recording material is not limited to the device of the electromagnetic induction heating type described in the exemplary embodiments. The heating device can be a halogen heater, an infrared lamp, a ceramic heater, or other devices. The heating device can employ an internal heating method.

(5) The image heating apparatus according to the present disclosure, as described in the above exemplary embodiments, is configured to heat and press a recording material with a pair of rotatable members in the nip portion. However, the image heating apparatus is not limited to that apparatus. For example, a device only for pressing a recording material in the nip portion with a pair of rotatable members is also possible.

(6) In the pressing mechanism, instead of the rotatable member contacting the front side that is the image bearing surface of the recording material, a mechanism for pressing a rotatable member contacting the back side of the recording material (mechanism for changing the pressure) can be employed. Further, a mechanism (mechanism for changing the pressure) for pressing both of a pair of rotatable members can be employed.

(7) The image forming method of the image forming apparatus is not limited to the electrophotographic method. For example, image forming methods such as an electrostatic recording method and a magnetic recording method can be employed. Further, a mechanism for directly transferring an image from a photosensitive member to a recording material without going through an intermediate transfer member can be employed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-163626 filed Jul. 24, 2012, which is hereby incorporated by reference herein in its entirety.

What is claimed is:

1. An image heating apparatus comprising:
first and second rotatable members configured to heat a toner image on a recording material at a nip portion therebetween;
a pressing mechanism configured to press the first rotatable member and the second rotatable member to come in contact with each other; and
a controller configured to control a pressure applied by the pressing mechanism,
wherein in a case where an image heating processing is performed on an envelope as the recording material, if the envelope has a width wider than a predetermined width, the controller sets the pressure to a first pressure, and if the envelope has a width less than or equal to the predetermined width, the controller sets the pressure to a second pressure, which is less than the first pressure.

2. The image heating apparatus according to claim 1, wherein in a case of an envelope having a width less than or equal to another predetermined width narrower than the predetermined width, the controller sets the pressure to a third pressure, which is less than the second pressure.

3. The image heating apparatus according to claim 1, wherein the pressing mechanism applies a pressure between the first rotatable member and the second rotatable member such that the pressure at a center portion becomes greater than the pressure at the both end portions in a longitudinal direction at the nip portion.

4. The image heating apparatus according to claim 1, wherein the pressing mechanism includes a pressing pad configured to press the first rotatable member from an inside of the rotatable member toward the second rotatable member, and the pad has a shape that gradually protrudes from the both end portions to a center portion in the longitudinal direction toward the second rotatable member.

5. The image heating apparatus according to claim 4, wherein the pressing mechanism presses both end portions of the pressing pad in a longitudinal direction toward the second rotatable member.

6. The image heating apparatus according to claim 5, wherein the second rotatable member is a roller in which an outer diameter of both end portions in the longitudinal direction is greater than an outer diameter of the center portion in the longitudinal direction.

7. The image heating apparatus according to claim 1, further comprising:
a heater configured to heat the first rotatable member.

8. The image heating apparatus according to claim 7, wherein the first rotatable member is provided at a side contacting an unfixed toner image on the recording material, and the first rotatable member is an endless belt driven and rotated by the second rotatable member.

9. The image heating apparatus according to claim 8, wherein the heater includes an exciting coil configured to heat the first rotatable member by electromagnetic induction heating.

10. An image heating apparatus comprising:
first and second rotatable members configured to heat a toner image on a recording material at a nip portion therebetween;
a pressing mechanism configured to press the first rotatable member and the second rotatable member to come in contact with each other; and
a controller configured to control a pressure by the pressing mechanism during an image heating operation, wherein the recording material is an envelope and based on a width and a grammage of the envelope.

11. The image heating apparatus according to claim 10, wherein in a case of an envelope having a width less than or equal to a predetermined width and a grammage greater than a predetermined grammage, the controller sets the pressure to a first pressure, and in a case of an envelope having a width less than or equal to the predetermined width and a grammage less than or equal to the predetermined grammage, the controller sets the pressure to a second pressure less than the first pressure.

12. The image heating apparatus according to claim 11, wherein in a case of an envelope having a width equal to or less than another predetermined width that is narrower than the predetermined width, the controller sets the pressure to a third pressure, which is less than the second pressure.

13. The image heating apparatus according to claim 10, wherein the pressing mechanism applies a pressure between the first rotatable member and the second rotatable member such that the pressure at a center portion becomes greater than a pressure at the both end portions in a longitudinal direction, at the nip portion.

14. The image heating apparatus according to claim 10, wherein the pressing mechanism includes a pad configured to press the first rotatable member from an inside of the rotatable member toward the second rotatable member, and the pad has a shape that gradually protrudes from both end portions to a center portion in a longitudinal direction toward the second rotatable member.

15. The image heating apparatus according to claim 14, wherein the pressing mechanism presses both end portions of the pressing pad in the longitudinal direction toward the second rotatable member.

16. The image heating apparatus according to claim 15, wherein the second rotatable member is a roller in which an outer diameter of the both end portions in the longitudinal direction is larger than that of the center portion in the longitudinal direction.

17. The image heating apparatus according to claim 16, further comprising:
a heater configured to heat the first rotatable member.

18. The image heating apparatus according to claim 17, wherein the first rotatable member is provided at a side contacting an unfixed toner image on the recording material, and the first rotatable member is an endless belt driven and rotated by the second rotatable member.

19. The image heating apparatus according to claim 18, wherein the heater includes an exciting coil configured to heat the first rotatable member in electromagnetic induction heating.
